(19) United States
(12) Patent Application Publication
(10) Pub. No.: US 2006/0198069 A1
(43) Pub. Date: Sep. 7, 2006

(54) Power ESD clamp protection circuit

(75) Inventors: Chien Hui Chuan, Xindian City (TW); Chih-Hung Wu, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Faraday Technology Corp.

(21) Appl. No.: 11/063,287

(22) Filed: Feb. 23, 2005

(51) Int. Cl. H02H 9/00

(52) U.S. Cl. 361/56

(57) ABSTRACT

An electrostatic discharge (ESD) protection circuit for protecting an input/output (I/O) circuit provided with different supply voltages against electrostatic discharge. The ESD protection circuit comprises a stacked NMOS transistor configuration, a triggering circuit and a disabling circuit. The ESD protection circuit is effectively disabled by the disabling circuit during normal operation. During an ESD event, a trigger current is generated by the triggering circuit to turn on the stacked NMOS transistor configuration and thus the ESD current is directed away. The ESD protection circuit also allows different voltages to be supplied during normal operation without damaging the transistors in the ESD protection circuit.

### BACKGROUND

The present invention relates to an electrostatic discharge (ESD) protection circuit, and, more particularly, to an electrostatic discharge (ESD) protection circuit protecting an input/output (I/O) circuit provided with different supply voltages against electrostatic discharge.

Electrostatic discharge (ESD) commonly occurs in semiconductor devices. The ESD phenomenon may occur when excessive electrostatic charge is drained through an I/O pad or a power pad of an integrated circuit (IC), damaging the IC. To solve this problem, manufacturers may provide an ESD protection circuit in IC devices. The ESD protection circuit is initiated before the pulse of electrostatic discharge exerts excessive pressure on IC devices, directing the ESD current to a potential terminal (preferably ground) to bypass IC devices, thus reducing the potential for ESD-related damage.

With the continuing demand for faster and smaller devices, however, there is a trend to scale down the dimensions of semiconductor integrated circuit (IC) devices. As a result, there arises a decrease in the gate length and gate oxide thickness of MOS devices, leaving IC devices more susceptible to damage from electrostatic discharge. That is, the safe operating voltage of these devices is reduced to a lower level. Consequently, an adequate and more effective ESD on-chip protection circuit must be designed to protect the IC against ESD-related damage.

Furthermore, many ICs are required to receive input signals from peripheral devices having an operating voltage exceeding the core logic voltage of the IC devices. Such I/O signals can cause reliability problems if a suitable voltage protection circuit capable of withstanding higher input signal voltages is not incorporated. Accordingly, it is desirable to have an ESD circuit allowing suitable protection for a lower core voltage circuit when higher input/output voltage is present.

Hence, there exists a need for a more effective ESD protection circuit for accommodating circuits with varying operating voltage range to overcome the problems of the related art.

### SUMMARY

The present invention is generally directed to an electrostatic discharge (ESD) protection circuit protecting an input/output (I/O) circuit provided with different supply voltages against electrostatic discharge. According to one aspect of the invention, the ESD protection circuit comprises a stacked NMOS transistor configuration, a triggering circuit and a disabling circuit. The stacked NMOS transistor configuration is coupled between a first power rail and a second power rail for receiving an ESD current from the first power rail and directing it to the second power rail during an ESD event. The stacked NMOS transistor configuration comprises at least a first NMOS transistor cascaded to a second NMOS transistor and has a gate coupled to a third power rail. The triggering circuit is coupled between the first power rail and the substrate of the stacked NMOS transistor configuration via a node. When an ESD event occurs, a trigger current is supplied to the stacked NMOS transistor configuration. The disabling circuit is coupled between the node and the second power rail for disabling the triggering circuit during normal operation. The third power rail has a third voltage level which is lower than the first voltage level of the first voltage rail but greater than the second voltage level of the second voltage rail during normal operation.

According to another aspect of the invention, an ESD protection circuit is disclosed. The ESD protection circuit comprises a stacked NMOS transistor configuration, a triggering circuit and a disabling circuit. The stacked NMOS transistor configuration is coupled between a first power rail and a second power rail for receiving an ESD current from the first power rail and directing it to the second power rail during an ESD event. The stacked NMOS transistor configuration comprises at least a first NMOS transistor and a second NMOS transistor. The first NMOS transistor has a drain connected to the first power rail, a gate connected to a third power rail via a first resistor, a source coupled to the drain of the second NMOS transistor and the gate of the second NMOS transistor is connected to the source of the second NMOS transistor and the second power rail. The triggering circuit is coupled between the first power rail and the substrate of the stacked NMOS transistor configuration and comprises diodes coupled in series including at least an anode coupled to the first power rail and a cathode coupled to the disabling circuit at a node wherein the diodes are conductive for supplying a trigger current to the stacked NMOS transistor configuration during an ESD event. The disabling circuit is coupled between the node and the second power rail for disabling the triggering circuit during normal operation. The third power rail has a third voltage level which is lower than the first voltage level of the first voltage rail but greater than the second voltage level of the second voltage rail during normal operation.

In one embodiment of the present invention, an ESD protection circuit comprises a stacked NMOS transistor configuration, a triggering circuit and a disabling circuit. The stacked NMOS transistor configuration is coupled between a first power rail and a second power rail for receiving an ESD current from the first power rail and directing the ESD current to the second power rail during an ESD event. The stacked NMOS transistor configuration comprises at least a first NMOS transistor and a second NMOS transistor wherein the first NMOS transistor has a drain connected to the first power rail, a gate connected to a third power rail via a first resistor, a source coupled to the drain of the second NMOS transistor and the gate of the second NMOS transistor connected to the source of the second NMOS transistor and the second power rail. Moreover, the transistors in the stacked NMOS transistor configuration are thin-gate devices. The triggering circuit is coupled between the first power rail and the substrate of the stacked NMOS transistor configuration via a node. The triggering circuit comprises a PMOS transistor including a source coupled to the first power rail, a drain coupled to the node and a gate coupled to the first power rail via a second resistor wherein the NMOS transistor is a thick-gate device and is turned on to generate the trigger current to the stacked NMOS configuration during an ESD event. The disabling circuit is coupled between the node and the second power rail for disabling the triggering circuit during normal operation. The third power rail has a third voltage level which is lower than the first voltage level of the first voltage rail but greater than the second voltage level of the second voltage rail during normal operation.

### BRIEF DESCRIPTION OF THE DRAWINGS

The invention can be more fully understood by reading the subsequent detailed description and examples with references made to the accompanying drawings, wherein:

FIG. 1 is a schematic diagram of an ESD protection circuit according to an embodiment of the invention; and

FIG. 2 is a schematic diagram of a charge pump according to another embodiment of the invention.

### DETAILED DESCRIPTION

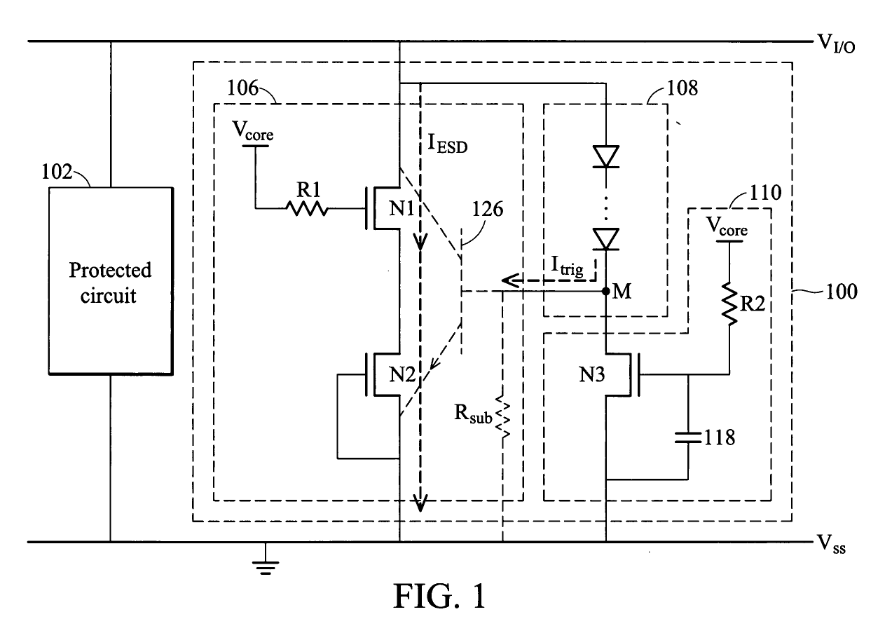

With reference to FIG. 1, a circuit diagram illustrates an ESD protection circuit 100 according to a first embodiment of the invention. The ESD protection circuit 100 of the invention is arranged between power rails V_{I/O} and Vₛₛ, and designed to protect a circuit 102 such as an I/O buffer, which is implemented by thin gate MOS transistors. Power rails V_{I/O} and Vₛₛ are connected respectively to an I/O voltage level V_{I/O} and Vₛₛ (preferably I/O ground). The ESD protection circuit 100 comprises a stacked NMOS configuration 106, a triggering circuit 108 and a disabling circuit 110.

The stacked NMOS transistor configuration 106 is arranged between power rails V_{I/O} and Vₛₛ and comprises at least a NMOS transistor N1 cascaded to a NMOS transistor N2. More particularly, the transistor N1 has a drain connected to power rail V_{I/O}, a gate connected to a power rail V_{core} with a core voltage level V_{core} via a resistor R1 and a source coupled to the drain of the transistor N2 wherein the core voltage level V_{core} is lower than I/O voltage level V_{I/O} and I/O ground voltage Vₛₛ is lower than V_{core}. The gate and source of transistor N2 are coupled together to power rail Vₛₛ. During normal operation, the gate to source voltage or the gate to drain voltage of the stacked NMOS transistor configuration 106 is within the supply voltage of core circuit, V_{core}. Thus, the stacked NMOS transistor configuration 106 can be implemented by thin gate NMOSs used in a core circuit while maintaining the reliability of the ESD protection circuit 100.

The disabling circuit 110 comprises a NMOS transistor N3 and a capacitor 118. The transistor N3 has a gate coupled to power rail V_{core} through a resistor R1, a source coupled to power rail Vₛₛ, and a drain coupled to the triggering circuit 108 and the substrate of the stacked NMOS transistor configuration 106 via a node M.

In this embodiment, the triggering circuit 108 comprises a diode string including at least an anode coupled to power rail V_{I/O} and a cathode coupled to the disabling circuit 110 at the node M where during normal operation, the number of diodes in the triggering circuit 108 is adjusted according to the desired leakage current at the work temperature and the desired threshold voltage for turning on the diode string during an ESD event.

During normal operation, the transistor N2 is turned off, hence, the ESD protection circuit 100 is high impedance and non-conductive during normal operation. Additionally, transistor N3 is turned on to draw away a leakage current, if any, from the triggering circuit 108, to avoid turning on the stacked NMOS configuration 106 during normal operation. Furthermore, the diodes in the triggering circuit 108 are turned off because the threshold voltage of diodes in the diode string is adjusted to be greater than voltage level V_{I/O}. Therefore, no trigger current is generated to trigger the stacked NMOS configuration 106.

During an ESD event, for example, where there is a positive voltage impulse occurring in power rail V_{I/O} and power rail Vₛₛ is grounded, the diodes in the triggering circuit 108 are turned on to conduct a trigger current while the ESD stress from power rail V_{I/O} is higher than the threshold voltage of the diode string. The capacitor 118 in the disabling circuit 110 is unable to react in time during an ESD impulse. Therefore, the gate of transistor N3 is grounded and transistor N3 is turned off during an ESD event. Consequently, the trigger current generated in the triggering circuit 108 is directed to the substrate of the stacked NMOS configuration 106 at node M and turns on the stacked NMOS configuration 106 to direct the ESD current to power rail Vₛₛ.

The stacked NMOS configuration 106 in the ESD protection circuit 100 further comprises a parasitic bipolar 126 and a parasitic resistor R_{sub} wherein the parasitic bipolar 126 has a collector connected to the drain of transistor N1, an emitter connected to the source of the transistor N2 and a base coupled to the node M, and R_{sub} is coupled between the node M and power rail Vₛₛ. During normal operation, the bipolar 126 is turned off. When an ESD event occurs, the trigger current from the triggering circuit 108 flows to the base of bipolar 126 and resistor R_{sub}. When the bias voltage in the base of bipolar 126 is greater than the threshold voltage of bipolar 126, the bipolar is turned on, directing the ESD current to power rail Vₛₛ. With a higher resistance of resistor R_{sub}, the bipolar 126 is turned on earlier. As a result, the ESD protection circuit 100 is able to draw the ESD current away from power rail V_{I/O} earlier. The voltage on the power rail V_{I/O} is thus clamped to a low voltage level so as to protect the circuit 102 from ESD damage. Moreover, according to designed, during normal operation, the stress level on the ESD protection circuit MOS transistor gates are all less than or equal to V_{core}. It would thus be desirable to utilize thin gate devices with the same gate thickness in the ESD protection circuit 100 and to reduce IC process costs.

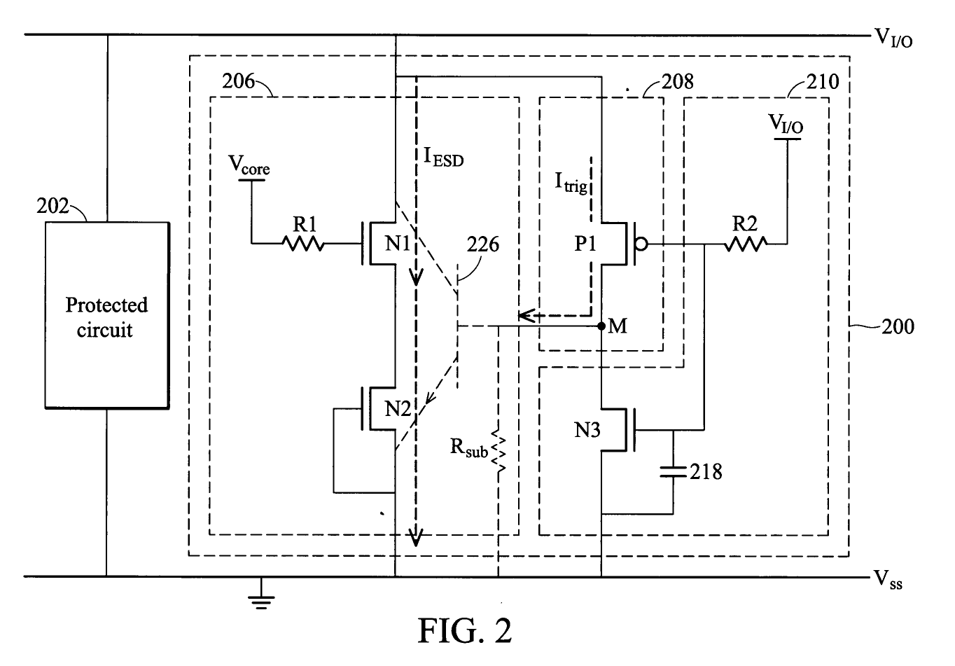

FIG. 2 illustrates another embodiment of the invention. The ESD protection circuit 200 is similar to that shown in FIG. 1 except that the triggering circuit 108 is replaced by a thick gate NMOS transistor P1 and transistor N3 is also a thick gate device having a gate coupled to power rail V_{I/O} via a resistor R2. In this embodiment, a thin gate device is fabricated to operate safely when its terminals are supplied with V_{core} or Vₛₛ voltage. Additionally, a thick gate device is provided for safe operation when terminals thereof are supplied with V_{I/O} or Vₛₛ voltage. Transistor P1 has a source coupled to power rail V_{I/O}, a gate coupled to power rail V_{I/O} through resistor R2 and a drain coupled to the disabling circuit 210 at node M. During normal operation, transistor P1 is turned off. When turned on by an ESD stress from power rail V_{I/O}, transistor P1 generates a trigger current during an ESD event. Similarly, the trigger current is directed to the bipolar 226 and the resistor R_{sub}. With a bias current generated in the bipolar 226, the stacked NMOS configuration 206 is turned on to discharge ESD current.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrostatic discharge (ESD) protection circuit for protecting an I/O circuit provided with different supply voltages against electrostatic discharge, the ESD protection circuit comprising:
a stacked NMOS transistor configuration coupled between a first power rail and a second power rail for receiving an ESD current from the first power rail and directing the ESD current to the second power rail during an ESD event, comprising at least a first NMOS transistor cascaded to a second NMOS transistor and having a gate coupled to a third power rail;
a triggering circuit coupled between the first power rail and the substrate of the stacked NMOS transistor configuration via a node, for supplying a trigger current to the stacked NMOS transistor configuration during an ESD event; and
a disabling circuit coupled between the node and the second power rail for disabling the triggering circuit during normal operation;
wherein the first power rail has a first voltage level, the second power rail has a second voltage level, the third power rail has a third voltage level and the third voltage level is lower than the first voltage level when the second voltage level is lower than the third voltage level during normal operation.

2. The ESD protection circuit as recited in claim 1, wherein the drain of the first NMOS transistor is connected to the first power rail, the gate of the first NMOS transistor is connected to the third power rail via a first resistor, the source of the first NMOS transistor is coupled to the drain of the second NMOS transistor, and the gate of the second NMOS transistor is connected to the source of the second NMOS transistor and the second power rail.

3. The ESD protection circuit as recited in claim 2, wherein the stacked NMOS configuration further comprises:
a parasitic bipolar formed in the substrate of the stacked NMOS transistor configuration, comprising a collector coupled to the drain of the first NMOS transistor, an emitter coupled to the source of the second NMOS transistor and a base coupled to the node for receiving the trigger current from the triggering circuit during an ESD event; and
a substrate resistor formed in the substrate of the stacked NMOS transistor configuration, coupled between the base of the parasitic bipolar and the second power rail, wherein a bias voltage at the base of the parasitic bipolar generates during an ESD event.

4. The ESD protection circuit as recited-in claim 1, wherein the triggering circuit comprises diodes coupled in series, including at least an anode coupled to the first power rail and a cathode coupled to the disabling circuit at the node and the diodes are conductive for generating the trigger current to the stacked NMOS configuration during an ESD event.

5. The ESD protection circuit as recited in claim 1, wherein the disabling circuit comprises:
a third NMOS transistor comprising a drain coupled to the node, a gate coupled to the first power rail via a resistor and a source coupled to the second power rail; and
a capacitor coupled between the gate of the third NMOS transistor and the second power rail;
wherein the NMOS transistor is a thick-gate device and the transistors in the stacked NMOS configuration are thin-gate devices.

6. The ESD protection circuit as recited in claim 1, wherein the disabling circuit comprises:
a third NMOS transistor comprising a drain coupled to the node, a gate coupled to the third power rail via a resistor and a source coupled to the second power rail; and
a capacitor coupled between the gate of the third NMOS transistor and the second power rail.

7. The ESD protection circuit as recited in claim 1, wherein the triggering circuit comprises a PMOS transistor including a source coupled to the first power rail, a drain coupled to the node and a gate coupled to the first power rail via a resistor, and the PMOS transistor is a thick-gate device when the transistors in the stacked NMOS configuration are thin-gate devices.

8. The ESD protection circuit as recited in claim 7, wherein the disabling circuit comprises:
a third NMOS transistor comprising a drain coupled to the drain of the PMOS transistor at the node, a gate coupled to the gate of the PMOS transistor and the first power rail via the resistor, and a source coupled to the second power rail; and
a capacitor coupled between the gate of the third NMOS transistor and the second power rail;
wherein the NMOS transistor is a thick-gate device.

9. An electrostatic discharge (ESD) protection circuit for protecting an I/O circuit provided with different supply voltages against electrostatic discharge, the ESD protection circuit comprising:
a stacked NMOS transistor configuration coupled between a first power rail and a second power rail for receiving an ESD current from the first power rail and directing the ESD current to the second power rail during an ESD event, comprising at least a first NMOS transistor and a second NMOS transistor wherein the first NMOS transistor has a drain connected to the first power rail, a gate connected to a third power rail via a first resistor, a source coupled to the drain of the second NMOS transistor and the gate of the second NMOS transistor connected to the source of the second NMOS transistor and the second power rail;
a triggering circuit coupled between the first power rail, and the substrate of the stacked NMOS transistor configuration, comprising diodes coupled in series including at least an anode coupled to the first power rail and a cathode coupled to the disabling circuit at a node wherein the diodes are conductive for supplying a trigger current to the stacked NMOS transistor configuration during an ESD event; and
a disabling circuit coupled between the node and the second power rail for disabling the triggering circuit during normal operation;
wherein the first power rail has a first voltage level, the second power rail has a second voltage level, the third power rail has a third voltage level and the third voltage level is lower than the first voltage level when the second voltage level is lower than the third voltage level during normal operation.

10. The ESD protection circuit as recited in claim 9, wherein the disabling circuit comprises:
a third NMOS transistor comprising a drain coupled to the node, a gate coupled to the third power rail via a second resistor and a source coupled to the second power rail; and
a capacitor coupled between the gate of the third NMOS transistor and the second power rail.

11. The ESD protection circuit as recited in claim 9, wherein the stacked NMOS configuration further comprises:
a parasitic bipolar formed in the substrate of the stacked NMOS transistor configuration, comprising a collector coupled to the drain of the first NMOS transistor, an emitter coupled to the source of the second NMOS transistor and a base coupled to the node for receiving the trigger current from the triggering circuit during an ESD event, and;
a substrate resistor formed in the substrate of the stacked NMOS transistor configuration, coupled between the base of the parasitic bipolar and the second power rail wherein a bias voltage generates at the base of the parasitic bipolar during an ESD event.

12. The ESD protection circuit as recited in claim 11, wherein the disabling circuit comprises:
a third NMOS transistor comprising a drain coupled to the node, a gate coupled to the third power rail via a second resistor and a source coupled to the second power rail; and
a capacitor coupled between the gate of the third NMOS transistor and the second power rail.

13. The ESD protection circuit as recited in claim 11, wherein the disabling circuit comprises:
a third NMOS transistor comprising a drain coupled to the node, a gate coupled to the first power rail via a second resistor and a source coupled to the second power rail; and
a capacitor coupled between the gate of the third NMOS transistor and the second power rail;
wherein the third NMOS transistor is a thick-gate device when the transistors in the stacked NMOS transistor configuration are thin-gate devices.

14. An electrostatic discharge (ESD) protection circuit for protecting an I/O circuit provided with different supply voltages against electrostatic discharge, the ESD protection circuit comprising:
a stacked NMOS transistor configuration coupled between a first power rail and a second power rail for receiving an ESD current from the first power rail and directing the ESD current to the second power rail during an ESD event, comprising at least a first NMOS transistor and a second NMOS transistor wherein the first NMOS transistor has a drain connected to the first power rail, a gate connected to a third power rail via a first resistor, a source coupled to the drain of the second NMOS transistor and the gate of the second NMOS transistor connected to the source of the second NMOS transistor and the second power rail wherein the transistors in the stacked NMOS transistor configuration are thin-gate devices;
a triggering circuit coupled between the first power rail, and the substrate of the stacked NMOS transistor configuration via a node, comprising a PMOS transistor including a source coupled to the first power rail, a drain coupled to the node and a gate coupled to the first power rail via a second resistor wherein the NMOS transistor is a thick-gate device, turned on to generate the trigger current to the stacked NMOS configuration during an ESD event; and
a disabling circuit coupled between the node and the second power rail for disabling the triggering circuit during normal operation;
wherein the first power rail has a first voltage level, the second power rail has a second voltage level, the third power rail has a third voltage level and the third voltage level is lower than the first voltage level when the second voltage level is lower than the third voltage level during normal operation.

15. The ESD protection circuit as recited in claim 14, wherein the disabling circuit comprises:
a third NMOS transistor comprising a drain coupled to the node, a gate coupled to the first power rail via the second resistor and a source coupled to the second power rail; and
a capacitor coupled between the gate of the third NMOS transistor and the second power rail;
wherein the third NMOS transistor is a thick-gate device.

16. The ESD protection circuit as recited in claim 14, wherein the stacked NMOS configuration further comprises:
a parasitic bipolar formed in the substrate of the stacked NMOS transistor configuration, comprising a collector coupled to the drain of the first NMOS transistor, an emitter coupled to the source of the second NMOS transistor and a base coupled to the node for receiving the trigger current from the triggering circuit during an ESD event; and
a substrate resistor formed in the substrate of the stacked NMOS transistor configuration, coupled between the base of the parasitic bipolar and the second power rail, wherein a bias voltage at the base of the parasitic bipolar generates during an ESD event.

17. The ESD protection circuit as recited in claim 16, wherein the disabling circuit comprises:
a third NMOS transistor comprising a drain coupled to the node, a gate coupled to the first power rail via the second resistor and a source coupled to the second power rail; and
a capacitor coupled between the gate of the third NMOS transistor and the second power rail;
wherein the NMOS transistor is a thick-gate device.
